(19) United States
(12) Patent Application Publication
(10) Pub. No.: US 2015/0120680 A1
(43) Pub. Date: Apr. 30, 2015

(54) DISCUSSION SUMMARY

(71) Applicant: Microsoft Corporation, Redmond, WA (US)

(72) Inventors: Omar Alonso, Redwood Shores, CA (US); Kartikay Khandelwal, Los Altos, CA (US); Mohamed Mansour, Mountain View, CA (US); Paul Ko, Mountain View, CA (US); Nina Mishra, Pleasanton, CA (US); Krishnaram Kenthapadi, Sunnyvale, CA (US); Abhimanyu Das, Sunnyvale, CA (US)

(73) Assignee: Microsoft Corporation, Redmond, WA (US)

(21) Appl. No.: 14/062,307

(22) Filed: Oct. 24, 2013

(51) Int. Cl. G06F 17/30

(52) U.S. Cl. CPC G06F 17/30719
USPC 707/692; 707/722

(57) ABSTRACT

One or more techniques and/or systems are provided for providing a discussion summary corresponding to a search query and/or for providing discussion session search results. For example, discussion data (e.g., corresponding to real-time messaging, such as a microblog discussion) may be evaluated to identify a discussion topic for a discussion sessions (e.g., a kitchen renovation topic may be assigned to a 1 hour exchange of kitchen renovation messages by a discussion group). A discussion summary of a discussion session may be provided based upon the discussion session having a discussion topic corresponding to a search query topic of a search query. The discussion summary may be provided along with other results for the query and may describe the discussion group, identifiers such as hashtags used by the discussion group, meeting dates/times, average number(s) of participants, other discussion sessions hosted by the discussion group, future discussion sessions, and/or other information.

### BACKGROUND

Many web services, websites, or applications provide messaging functionality through which users may exchange messages, facilitate discussions, or post information for others to view. In an example, a user may post a message and vacation pictures to a social network profile. In another example, a plurality of users may engage in a microblog discussion about an upcoming videogame console release. In this way, users may exchange information and ideas through such messaging functionality.

### SUMMARY

This summary is provided to introduce a selection of concepts in a simplified form that are further described below in the detailed description. This summary is not intended to identify key factors or essential features of the claimed subject matter, nor is it intended to be used to limit the scope of the claimed subject matter.

Among other things, one or more systems and/or techniques for providing a discussion summary corresponding to a search query and/or for providing discussion session search results are provided herein. In an example, a discussion data store may comprise discussion data corresponding to a variety of discussions between users (e.g., a microblog discussion on videogames, a message associated with an identifier such as a political message associated with a #dailypolitics hashtag, or any other discussion or message data). Discussion data, corresponding to a discussion session, may be identified (e.g., messages occurring between 2:00 pm and 3:00 pm on Mar. 14, 2013 with an identifier such as a hashtag #homerenovationchat may be identified as corresponding to a discussion session of a home renovation chat group). The discussion data may be evaluated to identify a discussion topic of the discussion session. For example, a digest, comprising a summary transcript of the discussion session may be generated. A lexical signature may be derived from and/or comprises one or more descriptive terms extracted from the digest (e.g., a “kitchen countertops” lexical signature, a “recommend granite” lexical signature, a “stainless steel sink” lexical signature, etc.). The discussion topic, such as a kitchen renovation discussion topic, may be identified from the digest and/or the lexical signature. In this way, discussion data may be evaluated to identify discussion groups (e.g., a group of users exchanging messages during a discussion session using similar identifiers), discussion sessions (e.g., an hour surge of discussion messages recurring on a weekly basis and using similar identifiers), discussion topics discussed during discussion sessions of the discussion groups, and/or other information that may be used to provide discussion summaries to users.

In an example of providing a discussion summary with search results, a search query may be identified. For example, a user may submit a search query “kitchen and bath ideas” through a search interface (e.g., a search website, an operating search interface such as a search charm, a search app, etc.). A search query topic associated with the search query may be determined, such as a home renovation search query topic. The discussion data store may be queried using the home renovation search query topic to identify one or more discussion sessions and/or discussion groups having discussion topics corresponding to the home renovation search query topic. For example, the discussion session corresponding to the hashtag #homerenovationchat may be identified. A discussion summary of the discussion session may be provided (e.g., a search results page, comprising search results corresponding to the search query “kitchen and bath ideas”, may be augmented with the discussion summary). The discussion summary may identify the home renovation chat group, the hashtag #homerenovationchat, the discussion session on Mar. 14, 2013, other discussion sessions of the home renovation chat group, an upcoming discussion session of the home renovation chat group, a recurring discussion meeting schedule of the home renovation chat group, a transcript such as the digest of the discussion session on Mar. 14, 2013, and/or a wide variety of other information that may provide the user with useful information about discussion sessions and/or discussion groups related to the search query “kitchen and bath ideas”.

It will be appreciated that discussions between users (e.g., a discussion group) may evolve over time, and thus discussion data from discussions between users may yield a first discussion topic at a first point in time and a second discussion topic at a second point in time, etc. Accordingly, a first discussion summary for a first discussion session from a discussion group at a first point in time, for example, may be presented within a first set of search results associated with a first search query topic (e.g., where the first search query topic corresponds to a first discussion topic of the first discussion session), whereas a second discussion summary for a second discussion session from the discussion group at a second point in time may be presented within a second set of search results associated with a second search query topic (e.g., where the second search query topic corresponds to a second discussion topic of the second discussion session). The first discussion summary may not be presented within the second set of search results and/or the second discussion summary may not be presented within the first set of search results (e.g., because the first search query topic does not correspond to the second discussion topic and/or the second search query topic does not correspond to the first discussion topic). It will be appreciated that discussions between users are fluid, not static, occur along a continuum, etc. such that the first discussion session and the second discussion session may be part of a same discussion session. Similarly, the first discussion session may have one or more sub-discussions where respective discussion topics may, for example, be identified for the different sub-discussions (e.g., where a sub-discussion may be regarded as a first discussion session or a second discussion session, etc.). That is, varying degrees of granularity are contemplated for discussions to identify discussion sessions. Accordingly, different discussion topics may be identified for a same discussion session such that respective discussion summaries for one or more portions of the discussion session may be presented within different sets of search results depending upon correspondence between discussion topics and search query topics, for example.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a flow diagram illustrating an exemplary method of providing a discussion summary corresponding to a search query.

FIG. 2 is a component block diagram illustrating an exemplary system for maintaining a discussion data store comprising discussion data.

FIG. 3A is a component block diagram illustrating an exemplary system for providing a discussion summary corresponding to a search query.

FIG. 3B is an illustration of an example of a discussion summary.

FIG. 4 is a component block diagram illustrating an exemplary system for providing a discussion summary corresponding to a search query.

FIG. 5 is a component block diagram illustrating an exemplary system for providing discussion session search results.

FIG. 6 is an illustration of an exemplary computer readable medium wherein processor-executable instructions configured to embody one or more of the provisions set forth herein may be comprised.

FIG. 7 illustrates an exemplary computing environment wherein one or more of the provisions set forth herein may be implemented.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide an understanding of the claimed subject matter. It may be evident, however, that the claimed subject matter may be practiced without these specific details. In other instances, structures and devices are illustrated in block diagram form in order to facilitate describing the claimed subject matter.

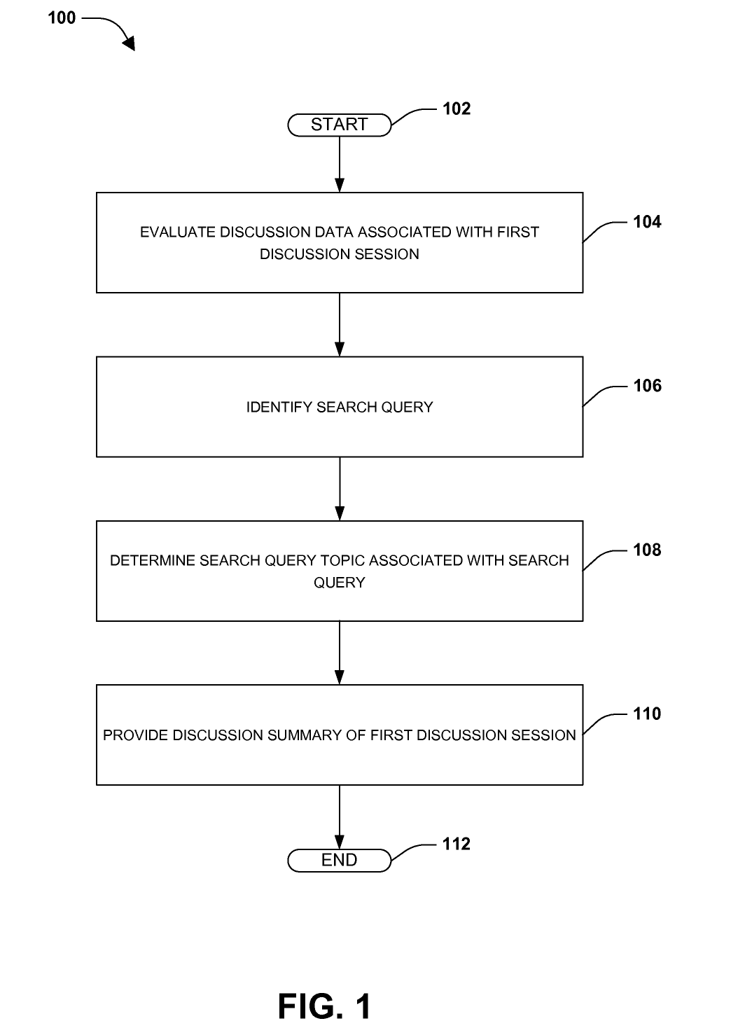

An embodiment of providing a discussion summary corresponding to a search query is illustrated by an exemplary method 100 of FIG. 1. At 102, the method starts. Discussion data may correspond to users communicating with one another, such as a discussion group that discusses various topics during a discussion session using one or more identifiers such as hashtags or any other message identifiers such as a topic identifier, a sender identifier, a recipient identifier, a subject identifier, a temporal identifier, a label, metadata, etc. (e.g., a videogame discussion group may meet weekly for an hour to discuss various videogame topics using hashtags relating to videogames such as #welovevideogames). In an example, discussion data corresponds to a real-time microblog session, a real-time discussion between a plurality of concurrently active participants, or any other type of communication (e.g., communication facilitated by a messaging service, communication facilitated by a discussion app, communication facilitated by a website, social network communication, messages tagged with a hashtag, etc.). The discussion data may be evaluated to identify discussion sessions, discussion groups, discussion topics of discussion sessions, and/or other information that may be used to generate discussion summaries.

At 104, discussion data associated with a first discussion session may be evaluated to identify a first discussion topic of the first discussion session. For example, a new videogame console discussion topic may be identified from discussion data associated with a discussion about an upcoming videogame console. In an example, the first discussion session may initially be identified (e.g., prior to identifying the first discussion topic) based upon a plurality of messages, having the hashtag #welovevideogames, occurring within a message activity temporal range (e.g., a threshold number of messages within a time range, such as at least 35 messages occurring within an hour time span, such as between 2:00 pm and 3:00 pm using the hashtag #welovevideogames, where relatively no message activity occurs for the hashtag #welovevideogames before or after 2:00 pm and 3:00 pm that day, thus indicating a discussion session from 2:00 pm to 3:00 pm). In this way, the first discussion session may be identified using the hashtag #welovevideogames, for example.

Once the first discussion session is identified, a digest may be generated for the first discussion session from the discussion data, where the digest may be used to identify the first discussion topic of the first discussion session. The digest may correspond to a summary transcript of the first discussion session. In an example, one or more messages within the discussion data may be collapsed into a discussion representation set. Filtering (e.g., removing unhelpful messages such as inappropriate messages or messages lacking descriptive terms), de-duplication (e.g., removing redundant messages), and/or clustering (e.g., grouping messages with similar content or terms) may be performed on the discussion representation set over the message activity temporal range (e.g., messages between 2:00 pm and 3:00 pm) to generate the digest. A lexical signature may be derived for the hashtag #welovevideogames based upon one or more descriptive terms extracted from the digest (e.g., a “new videogame console release” lexical signature, a “we love the new console” lexical signature, a “release date” lexical signature, etc.). In this way, the first discussion topic may be identified based upon the digest and/or the lexical signature.

In another example of identifying the first discussion session, the discussion data may be clustered into one or more clustered discussion sessions (e.g., the first discussion session Mar. 1, 2013 between 2:00 pm and 3:00 pm, a second discussion session Mar. 8, 2013 between 2:01 pm and 3:04pm, a third discussion session Mar. 15, 2013 between 2:00 pm and 3:02 pm, etc.). The discussion data may be clustered into the one or more clustered discussion sessions based upon a message count (e.g., a threshold number of messages indicative of a discussion session), a distinct user message count (e.g., multiple discussion participants indicative of a discussion session), a message activity temporal range (e.g., a threshold number of messages occurring within a threshold time span, thus indicative of a discussion session), etc. The first discussion session may be identified from the one or more clustered discussion sessions.

In an example, a digest may be created for a plurality of discussion sessions (e.g., discussions sessions associated with a hashtag, discussion sessions by a discussion/chat group, discussion sessions related to a particular topic/category, and/or any other grouping of discussions sessions). In this way, the digest may represent messages exchanged during the plurality of discussion sessions. The digest may be evaluated to identify lexical signatures that may describe what a community of users discussed in general. In an example, the plurality of discussion sessions correspond to discussion sessions during an event (e.g., such as the London Olympics), such that the lexical signatures may identify what was being discussed during the event.

At 106, a search query may be identified. In an example, the search query corresponds to a search query submitted through a search interface, such as a search app, a search website, a social network search, an operating system search interface such as a search charm, and/or any other search functionality. For example, a search query “best videogame consoles” may be identified. At 108, a search query topic associated with the search query may be identified, such as a videogame console search query topic. In an example, the discussion data store may be queried using the videogame console search query topic to identify one or more discussion sessions having discussion topics corresponding to the videogame console search query topic, such as the first discussion session having the new videogame console discussion topic.

At 110, responsive to the search query topic (e.g., videogame console search query topic) corresponding to the first discussion topic (e.g., new videogame console discussion topic), a discussion summary of the first discussion session may be provided. In an example, the discussion summary may identify one or more messages associated with the first discussion session. In another example, the discussion summary may identify a discussion group that participated in the first discussion session. In another example, the discussion summary may identify an identifier such as a hashtag or other message identifier used by the discussion group to tag the first discussion session. In another example, the discussion summary may identify a meeting time associated with the discussion group, such as every Monday between 2:00 pm and 3:00 pm. In another example, the discussion summary may identify the first discussion topic, a second discussion topic, and/or other discussion topics discussed during the first discussion session. In another example, the discussion summary may identify a second discussion session corresponding to the identifier and/or the discussion group. In another example, the discussion summary may identify a number of participants associated with the first discussion session. In another example, the discussion summary may identify a future meeting time for an upcoming discussion session by the discussion group. In this way, the discussion summary may identify a wide variety of information about the first discussion session, the discussion group, and/or other relevant information.

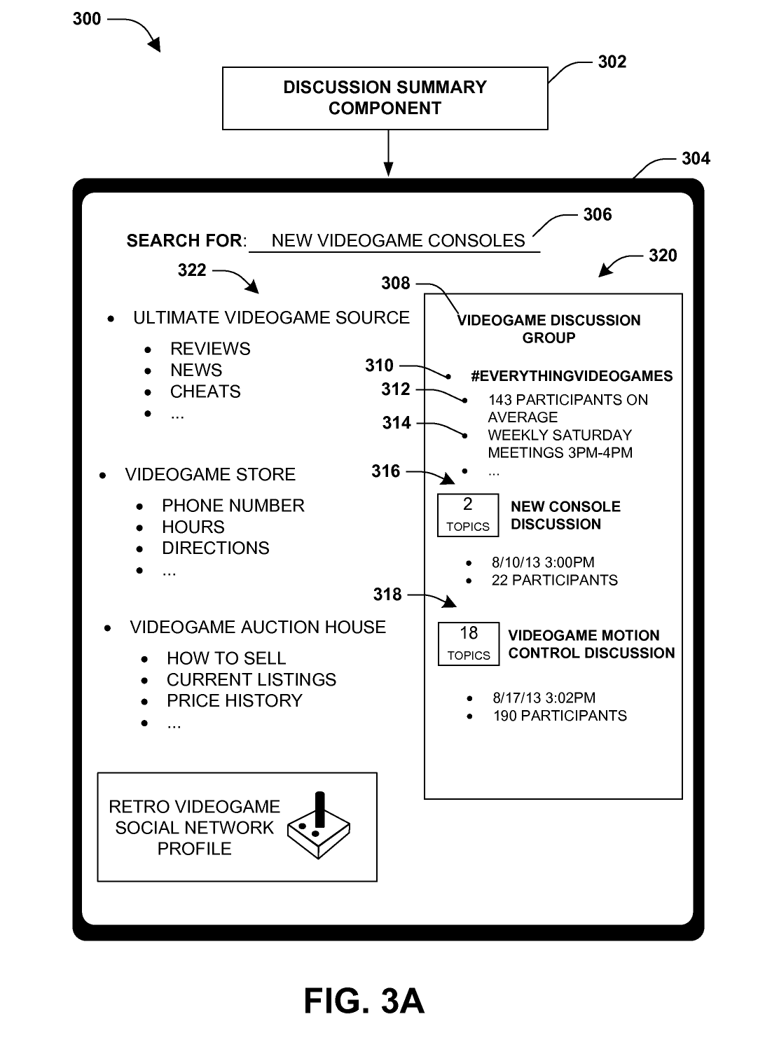

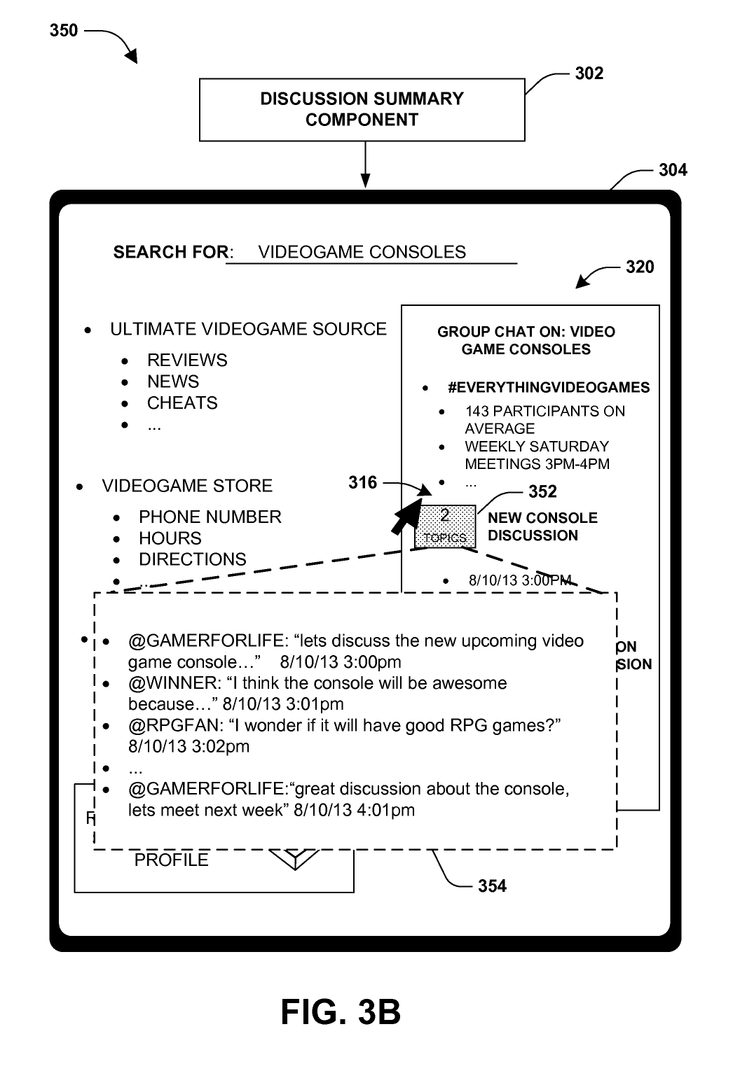

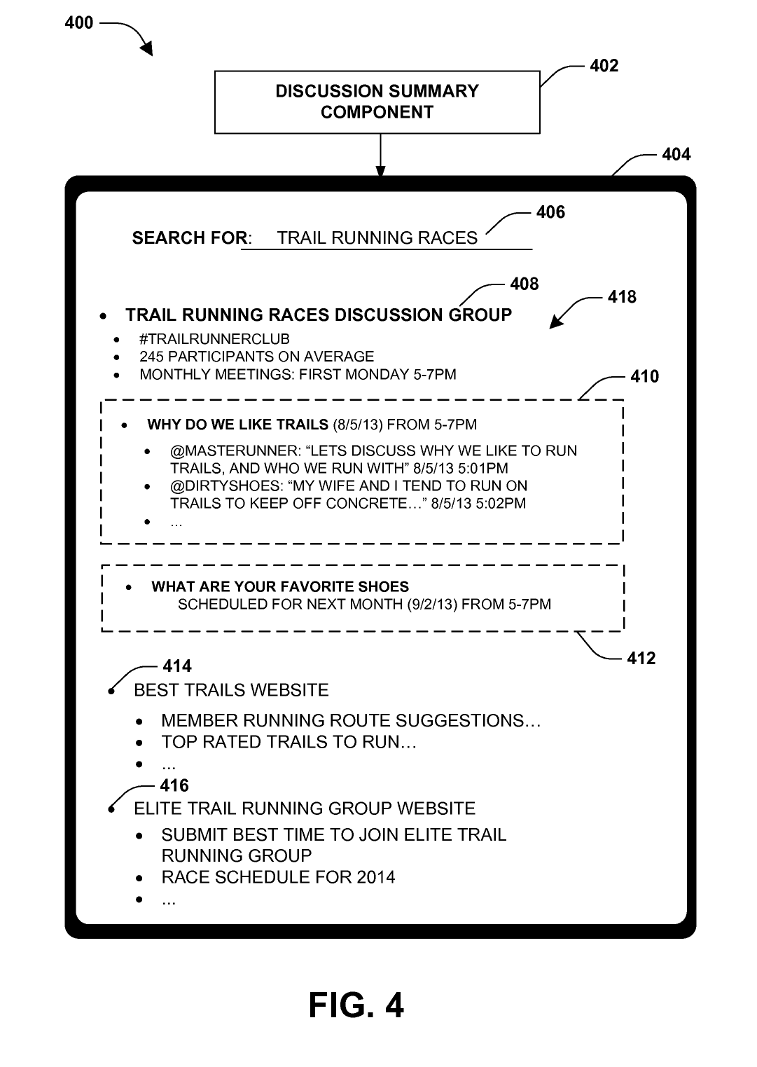

In an example, the discussion summary may be merged into a search results page for the search query to create an augmented search results page. For example, the discussion summary may be inserted as a sidebar interface (e.g., FIG. 3A), a topics view interface (e.g., FIG. 4), and/or other user interface element within the search results page. The sidebar interface and/or the topics view interface may specify one or more discussion topics discussed during one or more discussion sessions associated with the identifier of the first discussion session, for example. The topics view interface may specify one or more messages associated with the first discussion session. In this way, the augmented search results page may be displayed to the user. In an example, the discussion summary may be displayed as an interactive interface. For example, responsive to selection of the discussion summary, a discussion overview comprising one or more messages associated with the first discussion session may be displayed. Responsive to receiving a message search query pertaining to the discussion overview, a first message may be identified from the first discussion session based upon the first message corresponding to the message search query. The first message and/or other messages corresponding to the message search query may be displayed. In this way, the user may search for various messages within the first discussion session. At 112, the method ends.

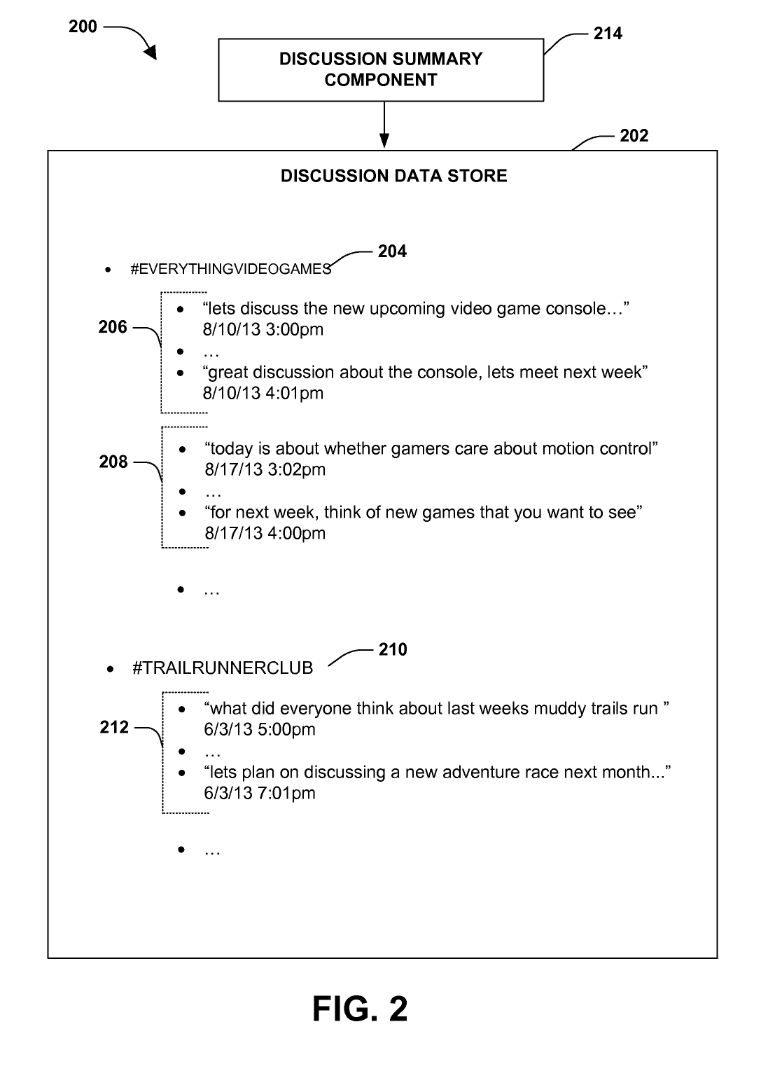

FIG. 2 illustrates an example of a system 200 for maintaining a discussion data store 202 comprising discussion data. The system 200 comprises a discussion summary component 214. The discussion summary component 214 may be configured to evaluate discussion data to identify discussion groups, discussion sessions, and/or discussion topics of discussion sessions. In an example, the discussion data corresponds to real-time microblog sessions, real-time discussions between a plurality of concurrently active participants, social network posts, messages tagged with identifiers, and/or any other message data.

The discussion data store 202 may, for example, comprise videogame discussion data corresponding to a hashtag #everythingvideogames 204. The discussion summary component 214 may be configured to cluster the videogame discussion data into a first cluster 206, a second cluster 208, and/or other clusters based upon various criteria, such as message count, distinct user message count, and/or a message activity temporal range (e.g., a threshold number of messages occurring within a timespan such as at least 50 messages occurring within a 30 minute timespan). For example, the first cluster 206 may comprise one or more messages, tagged with the hashtag #everythingvideogames 204, occurring between 3:00 pm and 4:01 pm on Aug. 10, 2013 based upon a threshold number of messages occurring between 3:00 pm and 4:01 pm indicating a first discussion session. The second cluster 208 may comprise one or more messages, tagged with the hashtag #everythingvideogames 204, occurring between 3:02 pm and 4:00 pm on Aug. 17, 2013 based upon a threshold number of messages occurring between 3:02 pm and 4:00 pm being indicative of a second discussion session. In this way, a videogame discussion group, which meets on a weekly basis between 3:00 pm to 4:00 pm to discuss topics related to the hashtag #everythingvideogames 204 and/or other hashtags, may be identified by the discussion summary component 214. A new console discussion topic and/or other discussion topics may be identified for the first cluster 206 by the discussion summary component 214 based upon the one or more messages clustered therein (e.g., message text such as “new upcoming video game console”, “console”, or other message text indicative of the new console discussion topic). A videogame motion control discussion topic and/or other discussion topics may be identified for the second cluster 208 by the discussion summary component 214 based upon the one or more messages clustered therein (e.g., message text such as “motion control” or other message text indicative of the videogame motion control discussion topic).

The discussion data store 202 may, for example, comprise trail runner discussion data corresponding to a hashtag #trailrunnerclub 210. The discussion summary component 214 may be configured to cluster the trail runner discussion data into one or more clusters such as a third cluster 212. For example, the third cluster 212 may comprise one or more messages, tagged with the hashtag #trailrunnerclub 210, occurring between 5:00 pm and 7:01 pm on Jun. 3, 2013 based upon a threshold number of messages occurring between 5:00 pm and 7:01 pm being indicative of a third discussion session. In this way, a trail runner club discussion group, which meets for 2 hour discussion sessions using the hashtag #trailrunnerclub 210 and/or other hashtags, may be identified by the discussion summary component 214. A running trail race discussion topic and/or other discussion topics may be identified for the third cluster 212 by the discussion summary component 214 based upon the one or more messages clustered therein (e.g., message text such as “muddy trails run”, “new adventure race”, etc.).

FIG. 3A illustrates an example of a system 300 configured for providing a discussion summary 320 corresponding to a search query. The system 300 comprises a discussion summary component 302. The discussion summary component 302 may be associated with a search interface 304. The discussion summary component 302 may be configured to identify a search query, such as a “new videogame consoles” search query 306, submitted through the search interface 304. The discussion summary component 302 may determine a search query topic associated with the “new videogame consoles” search query 306, such as a videogame consoles search query topic.

The discussion summary component 302 may determine that a videogame discussion group 308 has facilitated a new console discussion session 316, a videogame motion control discussion session 318, and/or other discussion sessions having discussion topics corresponding to the videogame consoles search query topic (e.g., the discussion summary component 302 may query the discussion data store 202 of FIG. 2 to identify such information). The discussion summary component 302 may be configured to generate a discussion summary 320 of the new console discussion session 316, the videogame motion control discussion session 318, and/or other discussion sessions corresponding to the videogame consoles search query topic. The discussion summary 320 may identify the videogame discussion group 308. The discussion summary 320 may identify an identifier, such as a hashtag #everythingvideogames 310, used by the videogame discussion group 308 during discussion sessions. The discussion summary 320 may identify an average participant count 312 for users participating in the discussion sessions of the videogame discussion group 308. The discussion summary 320 may identify a meeting schedule 314 for discussion sessions of the videogame discussion group 308. The discussion summary 320 may describe various information about individual discussions sessions, such as discussions topics, meeting times, participants, etc. In an example, the discussion summary 320 is merged into a search results page provided by the search interface 304. For example, the discussion summary 320 is inserted as a sidebar interface (e.g., adjacent to search results 322 comprised within the search results page).

In an example, the discussion summary 320 may be provided as an interactive interface through the search interface 304, as illustrated in example 350 of FIG. 3B. For example, responsive to a selection 352 of the new console discussion session 316, a discussion overview 354 may be displayed. The discussion overview 354 may comprise one or more messages associated with the new console discussion session 316. In an example, the discussion overview 354 may identify one or more discussion topics associated with the new console discussion session 316. It may be appreciated that a wide variety of information may be displayed through the discussion overview 354.

FIG. 4 illustrates an example of a system 400 configured for providing a discussion summary 418 corresponding to a search query. The system 400 comprises a discussion summary component 402. The discussion summary component 402 may be associated with a search interface 404. The discussion summary component 402 may be configured to identify a search query, such as a “trail running races” search query 406, submitted through the search interface 404. The discussion summary component 402 may determine a search query topic associated with the “trail running races” search query 406, such as a trail running search query topic.

The discussion summary component 402 may determine that a trail running races discussion group 408 has facilitated a why do we like trails discussion session 410 and/or other discussion sessions (e.g., the discussion summary component 402 may query the discussion data store 202 of FIG. 2 to identify such information). For example, the trail running races discussion group 408 may have an upcoming discussion session 412 next month regarding a what are your favorite shoes discussion topic. The discussion summary component 402 may be configured to generate the discussion summary 418 of the why do we like trails discussion session 410 and/or other discussion sessions corresponding to the “trail running races” search query 406. The discussion summary 418 may identify the trail running races discussion group 408, an identifier used by the trail running races discussion group (e.g., a hashtag #trailrunnerclub), an average participant count for users participating in the discussion sessions of the trail running races discussion group 408 (e.g., 245 participants on average), a meeting schedule (e.g., monthly meetings the first Monday of the month between 5:00 pm to 7:00 pm), and/or a variety of other information. The discussion summary component 402 may provide various information about the why do we like trails discussion session 410 through the discussion summary 418, such as a meeting date/time, one or more discussion topics associated with the why do we like trails discussion session 410, and/or one or more messages associated with the why do we like trails discussion session 410. The discussion summary 418 may comprise information regarding the upcoming discussion session 412. In an example, the discussion summary 418 is merged into a search results page provided by the search interface 404. For example, the discussion summary 418 may be inserted as a topics view interface positioned relative to one or more search results, such as above a first search result 414 and a second search result 416 associated with the “trail running races” search query 406.

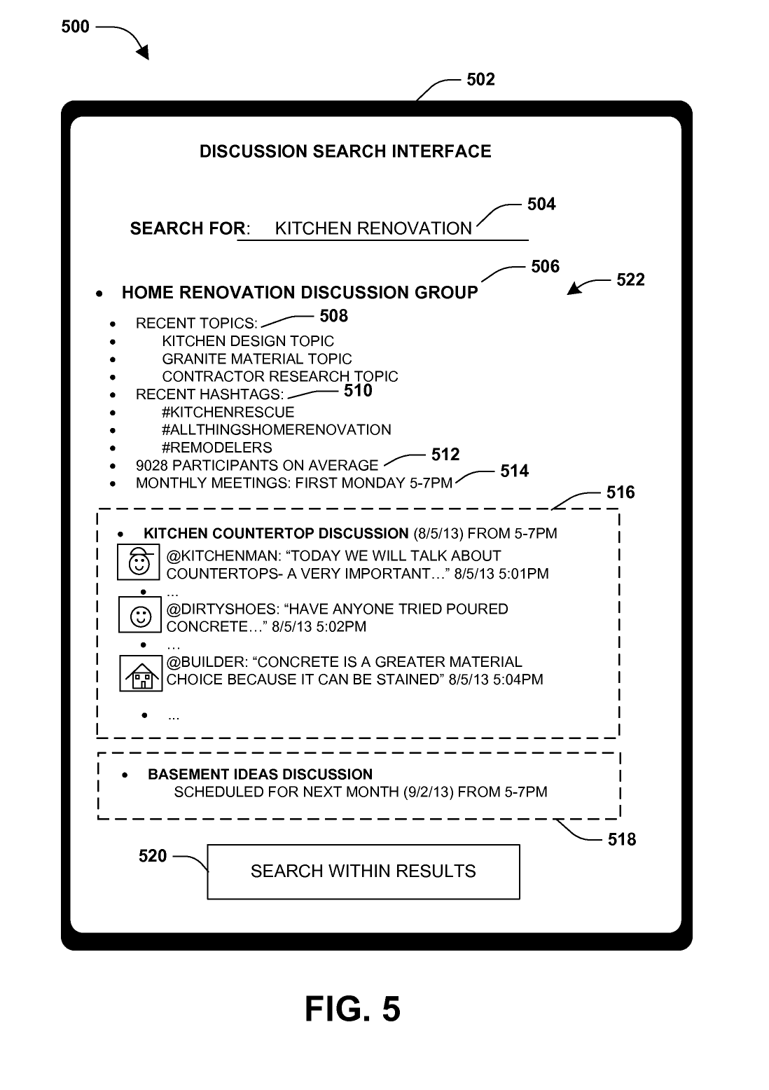

FIG. 5 illustrates an example of a system 500 for providing discussion session search results 522. The system 500 comprises a discussion search interface 502. The discussion search interface 502 may be configured to receive a discussion search query, such as a “kitchen renovation” discussion search query 504. The discussion search interface 502 may be configured to identify a discussion search query topic associated with the discussion search query. For example, a kitchen design discussion search query topic may be identified for the “kitchen renovation” discussion search query 504. The discussion search interface 502 may be configured to query a discussion data store (e.g., discussion data store 202 of FIG. 2) to identify a discussion session of a discussion group based upon the discussion session having a discussion topic corresponding to the discussion search query topic. For example, a kitchen countertop discussion 516, hosted by a home renovation discussion group 506, may have a kitchen design discussion topic that corresponds to the kitchen design discussion search query topic.

The discussion search interface 502 may be configured to display a discussion summary 522 of the discussion topic, the discussion group, and/or other relevant discussion information associated with the kitchen design discussion search query topic. The discussion summary 522 may identify the home renovation discussion group 506, one or more recent discussion topics 508 discussed by the home renovation discussion group 506 (e.g., the kitchen design discussion topic, a granite material discussion topic, a contractor research discussion topic, etc.), and/or one or more recent hashtags 510 used by the home renovation discussion group 506 (e.g., a #kitchenrescue hashtag, a #allthingshomerenovation hashtag, a #remodelers hashtag, etc.). The discussion summary 522 may identify an average number of discussion participants 512 (e.g., 9028 users on average may participate in discussion sessions hosted by the home renovation discussion group 506). The discussion summary 522 may identify a meeting schedule 514 for discussion sessions hosted by the home renovation discussion group 506 (e.g., monthly meetings on the first Monday of the month from 5-7 pm). The discussion summary 522 may identify one or more messages exchanged during the kitchen countertop discussion 516 (e.g., a first message by @kitchenman, a second message by @dirtyshoes, a third message by @builder, etc.). The discussion summary 522 may identify an upcoming meeting 518 for a future discussion session hosted by the home renovation discussion group 506 (e.g., a basement ideas discussion session). In an example, message search functionality may be exposed through a message search user interface element 520. For example, a user may invoke the message search user interface element 502 to perform a word search within one or more messages exchanged during the kitchen countertop discussion 516. For example, the discussion search interface 502 may display one or more messages related to granite based upon a “granite” message search query submitted through the message search user interface element 502.

In an example, the discussion search interface 502 may be configured to display discussion summaries corresponding to recurrent and/or high quality chat groups. For example, a videogame chat group may meet weekly to discuss various videogame topics. The videogame chat group may be identified as a high quality chat group based upon various criteria, such as a number of participants, an entity with which the videogame chat group is associated (e.g., a console manufacture or a well-known videogame website may facilitate the videogame chat group), etc. A discussion summary for the videogame chat group may specify a temporal frequency (e.g., times, dates, duration, etc.) at which the videogame chat group meets for discussion sessions. The discussion summary may provide a wide variety of other information, such as a discussion session transcript of messages exchanged during one or more discussion session. In an example, the discussion summary may identify key participants in a chat group, such as a moderator (e.g., a user with a threshold number of incoming @ messages in the chat session), active participants (e.g., users who attend a threshold number of meetings), a founder (e.g., a user that participates in a threshold number of chat sessions, such as starting from an initial chat session). In another example, the discussion summary may identify a webpage associated with a chat group (e.g., a URL of a webpage extracted from one or more messages within a chat session). In another example, the discussion summary may identify a geographic location associated with a chat group (e.g., a threshold number of messages originating from a particular geography location, such as a Rhode Island education chat #edchatri localized to Rhode Island (e.g., identified by computing a geographic center/radius of a chat group from latitudes/longitudes associated with messages of the chat group)). In this way, the discussion search interface 502 may provide various information that may be informative for a user who may desire to participate in particular discussions (e.g., the discussion search interface 502 may provide an invitation and/or other information for the user to join a future discussion session, receive information from one or more future discussion sessions, etc.).

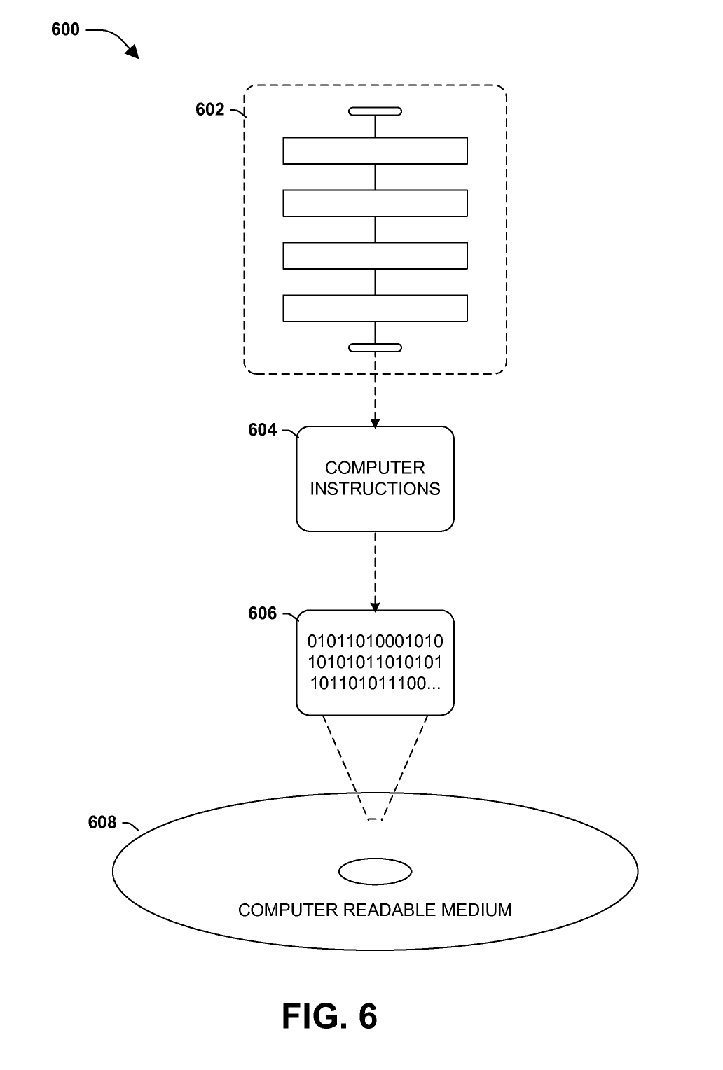

Still another embodiment involves a computer-readable medium comprising processor-executable instructions configured to implement one or more of the techniques presented herein. An example embodiment of a computer-readable medium or a computer-readable device is illustrated in FIG. 6, wherein the implementation 600 comprises a computer-readable medium 608, such as a CD-R, DVD-R, flash drive, a platter of a hard disk drive, etc., on which is encoded computer-readable data 606. This computer-readable data 606, such as binary data comprising at least one of a zero or a one, in turn comprises a set of computer instructions 604 configured to operate according to one or more of the principles set forth herein. In some embodiments, the processor-executable computer instructions 604 are configured to perform a method 602, such as at least some of the exemplary method 100 of FIG. 1, for example. In some embodiments, the processor-executable instructions 604 are configured to implement a system, such as at least some of the exemplary system 200 of FIG. 2, at least some of the exemplary system 300 of FIG. 3A, at least some of the exemplary system 400 of FIG. 4, and/or at least some of the exemplary system 500 of FIG. 5, for example. Many such computer-readable media are devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

As used in this application, the terms “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

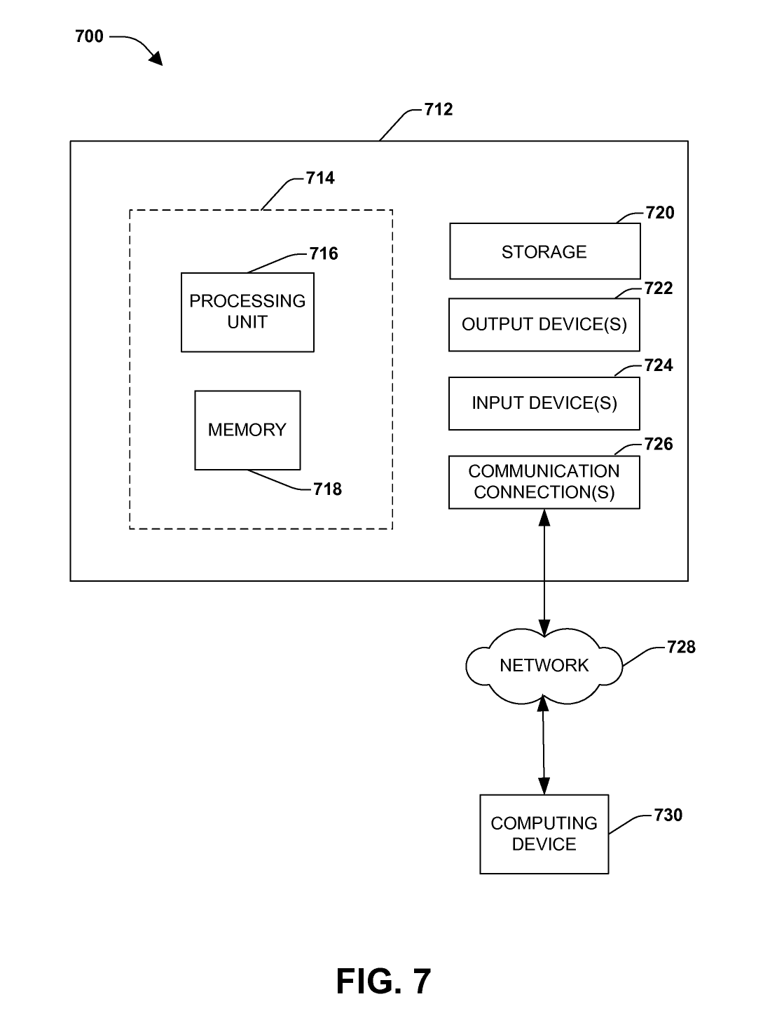

FIG. 7 and the following discussion provide a brief, general description of a suitable computing environment to implement embodiments of one or more of the provisions set forth herein. The operating environment of FIG. 7 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 7 illustrates an example of a system 700 comprising a computing device 712 configured to implement one or more embodiments provided herein. In one configuration, computing device 712 includes at least one processing unit 716 and memory 717. Depending on the exact configuration and type of computing device, memory 717 may be volatile (such as RAM, for example), non-volatile (such as ROM, flash memory, etc., for example) or some combination of the two. This configuration is illustrated in FIG. 7 by dashed line 714.

In other embodiments, device 712 may include additional features and/or functionality. For example, device 712 may also include additional storage (e.g., removable and/or non-removable) including, but not limited to, magnetic storage, optical storage, and the like. Such additional storage is illustrated in FIG. 7 by storage 720. In one embodiment, computer readable instructions to implement one or more embodiments provided herein may be in storage 720. Storage 720 may also store other computer readable instructions to implement an operating system, an application program, and the like. Computer readable instructions may be loaded in memory 717 for execution by processing unit 716, for example.

The term “computer readable media” as used herein includes computer storage media. Computer storage media includes volatile and nonvolatile, removable and non-removable media implemented in any method or technology for storage of information such as computer readable instructions or other data. Memory 717 and storage 720 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 712. Any such computer storage media may be part of device 712.

Device 712 may also include communication connection(s) 726 that allows device 712 to communicate with other devices. Communication connection(s) 726 may include, but is not limited to, a modem, a Network Interface Card (NIC), an integrated network interface, a radio frequency transmitter/receiver, an infrared port, a USB connection, or other interfaces for connecting computing device 712 to other computing devices. Communication connection(s) 726 may include a wired connection or a wireless connection. Communication connection(s) 726 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 712 may include input device(s) 724 such as keyboard, mouse, pen, voice input device, touch input device, infrared cameras, video input devices, and/or any other input device. Output device(s) 722 such as one or more displays, speakers, printers, and/or any other output device may also be included in device 712. Input device(s) 724 and output device(s) 722 may be connected to device 712 via a wired connection, wireless connection, or any combination thereof. In one embodiment, an input device or an output device from another computing device may be used as input device(s) 724 or output device(s) 722 for computing device 712.

Components of computing device 712 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 712 may be interconnected by a network. For example, memory 717 may be comprised of multiple physical memory units located in different physical locations interconnected by a network.

Those skilled in the art will realize that storage devices utilized to store computer readable instructions may be distributed across a network. For example, a computing device 730 accessible via a network 727 may store computer readable instructions to implement one or more embodiments provided herein. Computing device 712 may access computing device 730 and download a part or all of the computer readable instructions for execution. Alternatively, computing device 712 may download pieces of the computer readable instructions, as needed, or some instructions may be executed at computing device 712 and some at computing device 730.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein. Also, it will be understood that not all operations are necessary in some embodiments.

Further, unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “exemplary” is used herein to mean serving as an example, instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A method for providing a discussion summary corresponding to a search query, comprising:
evaluating discussion data associated with a first discussion session to identify a first discussion topic of the first discussion session;
identifying a search query;
determining a search query topic associated with the search query; and
responsive to the search query topic corresponding to the first discussion topic, providing a discussion summary of the first discussion session.

2. The method of claim 1, the providing a discussion summary comprising:
merging the discussion summary into a search results page for the search query to create an augmented search results page; and
displaying the augmented search results page.

3. The method of claim 2, the first discussion session corresponding to an identifier, and the merging the discussion summary comprising:
inserting the discussion summary as a sidebar interface, the discussion summary specifying one or more discussion topics discussed during one or more discussion sessions corresponding to the identifier.

4. The method of claim 2, the first discussion session corresponding to an identifier, and the merging the discussion summary comprising:
inserting the discussion summary as a topics view interface, the discussion summary specifying one or more discussion topics discussed during one or more discussion sessions corresponding to the identifier, the discussion summary specifying at least one message associated with the first discussion session.

5. The method of claim 1, the providing a discussion summary comprising:
displaying a number of participants associated with the first discussion session.

6. The method of claim 1, the providing a discussion summary comprising:
displaying the first discussion topic.

7. The method of claim 1, the providing a discussion summary comprising:
displaying a meeting time associated with a discussion group of the first discussion session.

8. The method of claim 1, the first discussion session corresponding to an identifier, and the providing a discussion summary comprising:
displaying a second discussion session corresponding to the identifier.

9. The method of claim 1, the providing a discussion summary comprising:
displaying the first discussion topic and a second discussion topic discussed during the first discussion session.

10. The method of claim 1, the discussion data corresponding to at least one of a real-time microblog session or a real-time discussion between a plurality of concurrently active participants.

11. The method of claim 1, comprising:
responsive to a selection of the discussion summary, displaying a discussion overview comprising one or more messages associated with the first discussion session.

12. The method of claim 11, the displaying a discussion overview comprising:
responsive to receiving a message search query pertaining to the discussion overview, displaying a first message, from the first discussion session, corresponding to the message search query.

13. The method of claim 1, the evaluating discussion data comprising:
identifying an identifier corresponding to the discussion data;
generating a digest from the discussion data, the digest corresponding to a summary transcript of the first discussion session;
deriving a lexical signature for the identifier based upon one or more descriptive terms extracted from the digest; and
identifying the first discussion topic based upon at least one of the digest or the lexical signature.

14. The method of claim 13, the generating a digest comprising:
collapsing one or more messages within the discussion data into a discussion representation set; and
performing at least one of filtering, du-duplication, or clustering on the discussion representation set over a message activity temporal range to generate the digest.

15. The method of claim 1, comprising:
clustering the discussion data into one or more clustered discussion sessions based upon at least one of a message count, a distinct user message count, or a message activity temporal range; and
identifying the first discussion session from the one or more clustered discussion sessions.

16. The method of claim 1, the providing a discussion summary comprising:
displaying a future meeting time for a future discussion session by a discussion group of the first discussion session.

17. The method of claim 1, comprising:
identifying a discussion group associated with the discussion session;
generating the discussion summary based upon at least one of one or more discussion sessions by the discussion group, a number of discussion participants of the discussion group, a discussion meeting time for the discussion group, or an identifier used by the discussion group for the one or more discussion sessions.

18. A system for providing a discussion summary corresponding to a search query, comprising:
a discussion summary component configured to:
evaluate discussion data associated with a first discussion session to identify a first discussion topic of the first discussion session, the discussion data corresponding to a real-time discussion of a discussion group;
identify a search query;
determine a search query topic associated with the search query; and
responsive to the search query topic corresponding to the first discussion topic, provide a discussion summary of the first discussion session.

19. The system of claim 18, the discussion summary component configured to:
identify an identifier corresponding to the discussion data;
generate a digest from the discussion data, the digest corresponding to a summary transcript of the first discussion session;
derive a lexical signature for the identifier based upon one or more descriptive terms extracted from the digest; and
identify the first discussion topic based upon at least one of the digest or the lexical signature.

20. A system for providing discussion session search results, comprising:
a discussion search interface configured to:
receive a discussion search query;
identify a discussion search query topic associated with the discussion search query;
query a discussion data store to identify a discussion session of a discussion group based upon the discussion session having a discussion topic corresponding to the discussion search query topic; and
display a discussion summary of the discussion topic, the discussion summary comprising at least one of an identifier used by the discussion group, a meeting time associated with the discussion group, a number of participants of the discussion session, one or more additional discussion sessions of the discussion group, a future meeting time for a future discussion session by the discussion group, or one or more messages exchanged during the discussion session.
